(19) United States
(12) Patent Application Publication
(10) Pub. No.: US 2026/0235355 A1
(43) Pub. Date: Aug. 13, 2026

(54) CARBON DIOXIDE SEPARATION PLANT USING EXTERNAL REFRIGERATION CIRCUIT, AND METHOD

(71) Applicant: NUOVO PIGNONE TECNOLOGIE - S.R.L., Florence (IT)

(72) Inventor: Olaf STALLMANN, Frankfurt, Hesse (DE)

(21) Appl. No.: 19/470,922

(22) PCT Filed: Mar. 27, 2024
(86) PCT No.: PCT/EP2024/025135

§ 371 Date: Sep. 30, 2025

(30) Foreign Application Priority Data
Mar. 31, 2023 (IT) 102023000006366
Jan. 25, 2024 (IT) 102024000001377

(51) Int. Cl. F25J 3/06

(52) U.S. Cl. CPC F25J 3/067; F25J 3/062; F25J 3/0695; F25J 2210/70; F25J 2220/02; F25J 2270/902

(57) ABSTRACT

A plant comprising a heat exchanger adapted to receive a compressed inlet flue gas stream and condense CO₂ contained in the compressed flue gas stream. The plant further comprises separation drums adapted to receive a chilled flue gas stream containing at least partly liquefied CO₂ from the heat exchanger, and to separate liquid CO₂ from the chilled flue gas stream. The pressurized CO₂ collected at the liquid outlet of the separation drums flows through a pressurized CO₂ outlet duct extending through the heat exchanger without expansion. The resulting liquefied or supercritical carbon dioxide at the outlet of the heat exchanger does not require to be compressed again. A refrigeration circuit removes heat from the inlet flue gas streaming through the heat exchanger.

### TECHNICAL FIELD

The invention relates to a device or plant and to a method for liquefaction of carbon dioxide (herein shortly CO₂) contained in a flue gas.

### BACKGROUND ART

CO₂ is generated by combustion of fuels, e.g. fossil fuels such as natural gas, in several power generation processes. CO₂ is a greenhouse gas having a negative impact on the climate and is responsible for climate changes and in particular global warming. While continuous efforts are being made to reduce the amount of power generated by combustion of fossil fuels, these still remain one of the major sources of energy.

Reducing the amount of CO₂ released in the atmosphere is becoming an important aspect of the recent policies aimed at reducing the climate impact of anthropic activities.

It has been known for a quite long time to remove CO₂ from flue gas by cryogenic separation. See e.g. EP2407741 and EP2365265. According to this known technology, compressed flue gas containing CO₂ flows through one or more heat exchangers in sequence, also referred to as cold-boxes, where heat is removed from the flue gas. The temperature reduction causes separation of CO₂ by liquefaction. The liquid CO₂ is used as the refrigerant in the heat exchanger. To reduce the temperature of the liquefied CO₂, the latter is expanded in an expander or through an expansion valve. The expanded and vaporized CO₂ flows through the cold side of the heat exchanger(s), while the compressed flue gas flows through the hot side of the heat exchanger.

The vaporized and heated carbon dioxide exiting the heat exchanger(s) is again compressed and liquefied by an intercooled CO₂ compressor train and finally collected in a storage or further transported in a pipeline.

The separation of carbon dioxide from a CO₂ containing flue gas is therefore a power-demanding process, which reduces the overall efficiency of the power generation process.

A method and a system capable of reducing the power required for carbon dioxide separation would therefore be welcomed in the art.

### SUMMARY

According to one aspect, disclosed herein is a plant for producing liquid CO₂ out of a flue gas. The plant comprises a heat exchanger adapted to receive a compressed inlet flue gas stream and condense at least part of the CO₂ contained in the compressed flue gas stream. The plant further comprises at least a first separation drum adapted to receive a chilled flue gas stream containing at least partly liquefied CO₂ from the heat exchanger, and to separate liquid CO₂ from the chilled flue gas stream. The pressurized CO₂ collected at the liquid outlet of the separation drum flows through a pressurized CO₂ outlet duct extending through the heat exchanger without expansion. The resulting liquefied or supercritical carbon dioxide at the outlet of the heat exchanger does not require to be compressed again. The power saved by avoiding a carbon dioxide compressor downstream of the heat exchanger is more than the power required to run a refrigeration circuit, which circulates a refrigerant, preferably a mixed refrigerant through the heat exchanger.

Specifically, the refrigeration circuit is therefore a closed circuit, adapted to circulate a refrigerant through the heat exchanger and remove heat from the heat exchanger to chill the compressed flue gas therewith. Condensing carbon dioxide is removed from the chilled flue gas. The refrigerant which circulates in the refrigeration circuit undergoes cyclic thermodynamic transformations to pump heat out from the flue gas flowing through the heat exchanger.

In embodiments, the mixed refrigerant can contain two or more hydrocarbons (CₓH_{y}), for example containing from 2 to 5 carbon atoms. In some embodiments, the mixed refrigerant can contain carbon dioxide (CO₂) and at least one hydrocarbon (CₓH_{y}), or more than one hydrocarbon. In some embodiments, each hydrocarbon can include a number of carbon atoms ranging from 2 to 5.

Preferably the mixed refrigerant may be a blend including (or not including) carbon dioxide, and at least a first hydrocarbon and a second hydrocarbon, wherein the first hydrocarbon has a lower liquefaction temperature and a lower number of carbon atoms (for instance two or three carbon atoms), and the second hydrocarbon has a higher liquefaction temperature and a higher number of carbon atoms (for instance from three to five, preferably from four to five, or more carbon atoms).

The refrigerant circulating in the closed refrigeration circuit undergoes cyclic thermodynamic transformations and removes thereby heat from the heat exchanger. A driver operates the compressor of the refrigeration circuit. The power required by the driver to operate the refrigeration circuit is less than the power which is usually required to re-compress carbon dioxide in those carbon dioxide capture and liquefaction processes, which use the same carbon dioxide as a heat removing medium in an open refrigeration system, as disclosed in the prior art documents mentioned above.

In some embodiments, the plant comprises a plurality of separation drums arranged in series. The gas outlet of each upstream separation drum, except the most downstream one, is fluidly coupled to the inlet of the next separation drum through a duct which extends through the heat exchanger to remove heat from the flue gas and promote condensation of additional CO₂ contained in the flue gas. The streams of pressurized liquid CO₂ from each separation drum can be processed through a pumping unit to increase the pressure thereof before flowing the streams of pressurized CO₂ through the heat exchanger.

CO₂-lean flue gas exits the gas outlet of the most downstream separation drum. The remaining flue gas can be recycled or treated in any suitable manner, depending on the source of flue gas and therefore on the chemical composition thereof after (full or partial) CO₂ removal.

If needed, the liquid carbon dioxide collected at the liquid outlet of each separation drum can be further pressurized by a pumping unit, if the pressure at which the flue gas is delivered to the heat exchanger is not sufficient.

Whether a pumping unit is needed or not depends, for instance, upon the final CO₂ conditions (pressure and temperature) required at the output of the plant. In some embodiments the carbon dioxide is delivered at the outlet of the heat exchanger at a pressure ranging between 5 barA and 90 barA at a temperature below the bubble point temperature at the delivery pressure. If the required final CO₂ pressure is at or below approximately 40 barA, an additional pumping unit may be dispensed with. The pressure at which the flue gas is delivered to the plant can be sufficient to reach the required final carbon dioxide pressure. Flue gas can be compressed upstream of the heat exchanger, e.g. by means of a flue gas compressor unit. If a higher output CO₂ pressure is required, for instance above 40 barA, a pumping unit is arranged between the separation drum(s) and the heat exchanger along the CO₂ flow path.

According to a further aspect, disclosed herein is a method for producing liquid CO₂ out of a flue gas, the method comprising the following steps:
delivering a stream of compressed flue gas containing CO₂ through a heat exchanger in heat exchange with a refrigerant;
at least partially condensing CO₂ contained in the compressed flue gas by heat exchange with said refrigerant;
separating a first stream of pressurized liquid CO₂ from the stream of compressed flue gas in a first separation drum;
removing the first stream of pressurized liquid CO₂ from the first separation drum; and
flowing the first stream of pressurized CO₂ through a CO₂ outlet duct extending through the heat exchanger and removing the first stream of pressurized CO₂ from the heat exchanger.

The method can comprise the further step of processing the streams of pressurized liquid CO₂ from each separation drum through a pumping unit to further increase the pressure thereof before flowing the streams of pressurized CO₂ through the heat exchanger, depending upon the final carbon dioxide pressure required at the output of the plant.

Further features and embodiments of the plant and of the method according to the present disclosure are described below and set forth in the appended claims.

### BRIEF DESCRIPTION OF THE DRAWINGS

Reference is now made briefly to the accompanying drawings, in which:

FIG. 1 is a diagram of a plant according to the present disclosure in one embodiment;

FIG. 2 is an enlarged detail of the diagram of FIG. 1, showing the heat exchanger;

FIG. 3 is a diagram of a plant according to the present disclosure in a further embodiment;

FIG. 4 is an enlarged detail of the diagram of FIG. 2; and

FIG. 4A is a schematic enlargement of detail A in FIG. 4.

### DETAILED DESCRIPTION

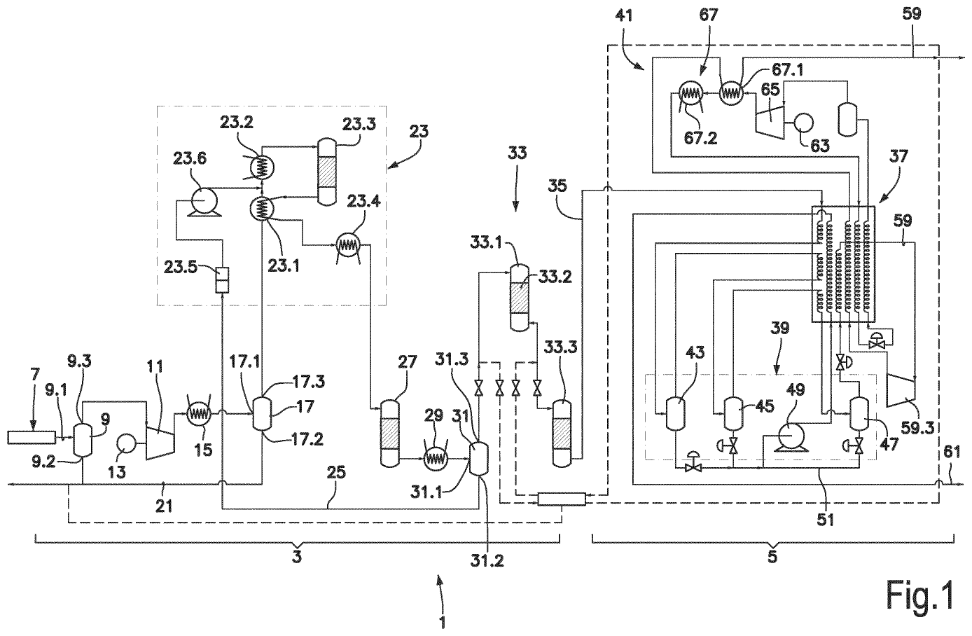

A schematic diagram of a plant according to the present disclosure is shown in FIG. 1. The plant 1 comprises a pre-treatment section 3 and a carbon dioxide liquefaction section 5. The plant 1 can be used for instance to remove carbon dioxide from a flue gas produced by a fuel cell system, for instance a solid oxide fuel cell (SOFC) system, which uses natural gas as a fuel.

The pre-treatment section 3 comprises a flue gas inlet 7 fluidly coupled to a source of flue gas, for instance a fuel cell arrangement, or another source of flue gas, such as a gas turbine engine or the like.

The pre-treatment section 3 can include a first liquid-vapor separator 9 having an inlet 9.1 fluidly coupled to the flue gas inlet 7, a liquid outlet 9.2 and a gas outlet 9.3.

The gas outlet 9.3 of the first liquid-vapor separator 9 is fluidly coupled with a suction side of a flue gas compressor unit 11, herein after referred to simply as compressor unit 11.

The compressor unit 11 is represented as a single compressor for the sake of simplicity. In some embodiments, the compressor unit 11 can include an intercooled multi-stage compressor or compressor train. The delivery side of the compressor unit 11 is connected to a post-cooler 15 and a second liquid-vapor separator 17, which comprises an inlet 17.1, a liquid outlet 17.2 and a gas outlet 17.3. Condensed water from the liquid outlet 9.2 of the first liquid-vapor separator 9 and from the liquid outlet 17.2 of the second liquid-vapor separator 17 is collected in a condensate removal line 21.

In some embodiments, the pre-treatment section 3 can include a water-gas-shift reactor system 23 (shortly WGS reactor), adapted to convert carbon monoxide possibly contained in the flue gas and steam into carbon dioxide and hydrogen. The water gas shift reactor system 23 comprises a preheater 23.1, a heater 23.2, a reactor 23.3, a cooler 23.4, a water filter 23.5 and a water pump 23.6. The water filter 23.5 and the water pump 23.6 are located along a condensate recycling line 25 which feeds condensate from a third liquid-vapor separator to be described below.

As mentioned above, the compressor unit 11 usually includes a plurality of compressors or compressor stages with at least one interstage cooler or intercooler. In such case, a preferred location for the WGS reactor will be after a first stage of the compressor unit 11, directly before the interstage cooler. At this location preheater 23.1 and maybe even heater 23.2 may be avoided, when making use of the heat of compression. Depending of the water content of the incoming gas, that location may even allow to avoid pump 23.6.

The flue gas treated in the water-gas-shift reactor 23, if present, can be fed through further components of the pre-treatment section 3. In the embodiment of FIG. 1 the pre-treatment section 3 includes, for instance, a mercury absorber 27 followed by a cooler 29 which is in turn fluidly coupled to the inlet 31.1 of a third liquid-vapor separator 31, including a liquid outlet 31.2 and a gas outlet 31.3. The third liquid-vapor separator 31 is adapted to separate water condensate from the flue gas. The condensate is delivered to the water-gas-shift reactor 23 through the condensate recycling line 25. If the water-gas-shift reactor 23 is not present, the liquid outlet 31.2 of the third liquid-vapor separator 31 can be coupled to the condensate removal line 21, for instance.

The gas outlet 31.3 of the third liquid-vapor separator 31 is fluidly coupled to a flue gas dryer arrangement 33. The flue gas dryer arrangement 33 is schematically represented as an adsorption-type single flue gas dryer section 33.1 containing a desiccant bed 33.2. However, in order to allow continuous operation of the plant, the flue gas dryer arrangement 33 usually includes two flue gas dryer sections, such that while one flue gas dryer section is operating, the other flue gas dryer section undergoes a regeneration cycle to regenerate the desiccant, e.g., by a carbon dioxide stream or another water-lean gas stream, not shown. A filter 33.3 is arranged downstream of the flue gas dryer section, or of each flue gas dryer section to prevent adsorbent fines transport into the downstream section.

The dehydrated flue gas is delivered from the pre-treatment section 3 to the carbon dioxide liquefaction section 5 through a pre-treated flue gas inlet line 35.

In other embodiments, the water-gas shift reactor system 23 can be dispensed with. In such case, flue gas can be delivered from the flue gas inlet 7 directly to the flue gas cooler 29 and to the flue gas dryer arrangement 33, possibly after processing through the compressor unit 1 and liquid-vapor separator 17.

The carbon dioxide liquefaction section 5 comprises a heat exchanger, aka cold box, 37, a liquefied carbon dioxide removal unit 39 and a refrigeration circuit 41. As will be described in more detail below, the refrigeration circuit 41 is a closed circuit. A refrigerant, such as in particular a mixed refrigerant (MR), circulates and undergoes cyclic thermodynamic transformations to remove heat from the cold box or heat exchanger 37. The refrigeration circuit is separate from the flue gas and CO₂ circuit.

More in detail, the carbon dioxide removal unit 39 includes a first separation drum 43, an intermediate separation drum 45 and a further separation drum 47. The intermediate separation drum 45 will be referred herein also as the second separation drum and the further separation drum 47 will be referred to herein also as the third separation drum. In other embodiments, not shown, the number of separation drums can be less than three or more than three. For instance, in one embodiment the liquefied carbon dioxide removal unit 39 can include only the first separation drum 43, or only the first and the third separation drums 43, 47, or more than three separation drums in sequence.

Generally speaking, each separation drum, except the last one, has a gas outlet fluidly coupled to an inlet of the next separation drum through a connection line which extends through the heat exchanger, or cold-box, 37.

When CO₂ terminal delivery conditions are higher than the liquefaction operating conditions, the liquefied carbon dioxide removal unit 39 further comprises a pumping unit which, in the schematic of FIG. 1, is represented as a single pump 49. The pumping unit 49 has a suction side 49.1 and a delivery side 49.2. The suction side 49.1 of the pumping unit 49 is fluidly coupled to each liquid outlet of each separation drum.

Specifically, in the embodiment of FIG. 1, the first separation drum 43 has an inlet 43.1, a liquid outlet 43.2 and a gas outlet 43.3. The second or intermediate separation drum 45 has an inlet 45.1, a liquid outlet 45.2 and a gas outlet 45.3. The third or further separation drum 47 has an inlet 47.1, a liquid outlet 47.2 and a gas outlet 43.3. The liquid outlets 43.2, 45.2 and 47.2 are connected through a collector line 51, to the suction side 49.1 of the pumping unit 49.

The inlet 43.1 of the first separation drum 43 is connected to the pre-treated flue gas inlet line 35 through a first heat exchanging connection 53 extending through the heat exchanger 37. The gas outlet 43.3 of the first separation drum 43 is connected to the inlet of the second, or intermediate, separation drum 45 through a connection duct 55 comprising second heat exchanging connection 55.1, extending through the heat exchanger 37. The gas outlet 45.3 of the second, or intermediate, separation drum 45 is connected to the inlet 47.1 of the third, or further, separation drum 47 through a connection duct 57, comprising a third heat exchanging connection 57.1 extending through the heat exchanger 37.

The connection 57 and the intermediate or second separation drum 45 form a fluid connection between the gas outlet of the first separation drum and the inlet of the further, or third, separation drum 47.

The gas outlet 47.3 of the third, or further, separation drum 47 is fluidly coupled with a gas discharge duct 59. The gas discharge duct 59 has a first heat exchange section 59.1 and a second heat exchange section 59.2 arranged in sequence and extending through the heat exchanger 37. An expansion device, such as an expansion valve or an expander, is located along the gas discharge duct 59 between the first heat exchange section 59.1 and the second heat exchange section 59.2. In the schematic of FIG. 1 the expansion device includes an expander 59.3.

The delivery side of the pumping unit 49.2 is connected to a pressurized CO₂ outlet duct 61, wherethrough the pressurized liquid CO₂ is removed. The CO₂ outlet duct 61 includes a heat exchange section 61.1 extending through the heat exchanger 37.

The refrigeration circuit 41 comprises a compression section, a refrigerant cooling and condensing section, a refrigerant expander section, a heat rejection section, and a heat absorption section. A refrigerant flows through the refrigeration circuit 41 and undergoes cyclic thermodynamic transformations to pump heat out of the heat exchanger 37 using mechanical power generated by a driver, for instance an electric motor or a turbine.

In the schematic of FIG. 1 the driver is shown at 63 and the compression section is represented as a single compressor 65. It shall be understood that the compression section can include more than one compressor or a multistage compressor, possibly an intercooled multistage compressor or compressor train. In the embodiment of FIG. 1, the refrigerant cooling and condensing section comprises refrigerant cooler 67.1 and a refrigerant condenser 67.2. Downstream of the refrigerant condenser 67.2 the refrigeration circuit comprises a heat rejection flow path 69, extending through the heat exchanger 37 and a heat absorption flow path 73. A refrigerant expansion device, for instance an expansion valve 71, or an expander, is placed between the heat rejection flow path 69 and the heat absorption flow path 73.

The plant 1 operates as follows.

A CO₂-rich flue gas is fed to the plant 1 through the flue gas inlet 7. CO₂-rich flue gas can be generated by a fuel cell arrangement, such as a SOFC arrangement, and contains carbon dioxide in combination with other species, such as water, carbon monoxide, hydrogen, and possible contaminants. The flue gas is compressed in the flue gas compressor unit 11 and cooled in the post-cooler 15 to remove water therefrom. Condensate is removed from the compressed flue gas in the first liquid-vapor separator 17 and collected in the condensate removal line 21.

The compressed flue gas from the first liquid-vapor separator 17 is then processed in the water-gas-shift reactor system 23, if required, e.g., to convert carbon monoxide and water into carbon dioxide and hydrogen.

After water-gas-shift conversion (if provided) the flue gas flows through optional mercury absorber 27 and through the cooler 29. The flue gas is pre-cooled in the cooler 29. Condensate (water) separating from the flue gas by cooling in cooler 29 is removed from the flue gas in the second liquid-vapor separator 31. After condensate removal, the flue gas is processed through the dryer section 33.1 to remove residual moisture and is finally fed from the pre-treatment section 3 to the carbo dioxide liquefaction section 5.

In the carbon dioxide liquefaction section the flue gas flows firstly through the first heat exchanging connection 53, where the flue gas is chilled in heat exchange with the refrigerant circulating in the refrigeration circuit 41, such that a fraction of carbon dioxide is liquefied and separated from the flue gas stream in the first separation drum 43.

The gaseous fraction of the flue gas exits the first separation drum 43 and flows through the connection duct 55 and through the second heat exchanging connection 55.1, extending through the heat exchanger 37, where the flue gas is further chilled in heat exchange with the refrigerant. A second fraction of carbon dioxide is liquefied and separated from the gaseous stream in the intermediate separation drum 45.

The gaseous stream from the intermediate separation drum 45 flows through the connection duct 57 and the third heat exchanging connection 57.1 extending through the heat exchanger 37 in heat exchange with the refrigerant. The carbon dioxide liquefied in the heat exchanging connection 57.1 is separated from the gaseous stream in the further separation drum 47.

The stream of the resulting CO₂-lean flue gas flows from the further separation drum 47 through the heat exchange section 59.1 of the gas discharge duct 59 and expanded in the expander 59.3. The temperature of the expanded CO₂-lean flue gas is thus reduced and the chilled CO₂-lean flue gas flows through the second heat exchange section 59.2 to remove heat from the heat exchanger 37. The expanded CO₂-lean flue gas is finally discharged through the refrigerant cooler 67.1.

The resulting, CO₂-lean flue gas can be processed in different ways depending upon the composition thereof. For instance, if the flue gas is generated by a SOFC arrangement, the CO₂-lean flue gas can contain hydrogen and can be fully or partly recycled towards the fuel cell arrangement.

The liquid carbon dioxide collected at the first separation drum 43, intermediate separation drum 45 and further separation drum 47 is pressurized by pumping unit 49 and removed from the CO₂-liquefaction section 5 through the CO₂ outlet duct 61. The liquid carbon dioxide is heated in the heat exchange section 61.1 extending through the heat exchanger 37 to the required final temperature. The pressure at which the pumping unit 49 pressurizes the liquid carbon dioxide is such that the carbon dioxide remains in the liquid state and does not change state from liquid to vapor. This avoids the need to compress the carbon dioxide discharged from the heat exchanger 37.

The refrigerant circulating in the closed refrigeration circuit 41 can be a mixed refrigerant, the composition whereof can be selected such that the required outlet temperature of the carbon dioxide in the CO₂ outlet duct is achieved.

In some embodiments the mixed refrigerant contains at least two components, one component being CO₂ and the other being a component having a boiling point temperature higher than CO₂.

In some embodiments, the mixed refrigerant contains a blend of carbon dioxide, and one or more hydrocarbons CₓH_{y} containing from 1 to 5 carbon atoms, preferably from 1 to 5 carbon atoms and possibly nitrogen. For instance, the one or more hydrocarbons can be selected from the group consisting of propane, propylene, iso-butane, iso-pentane.

In some embodiments, the mixed refrigerant may contain CO₂ from 10 to 85% and nitrogen from 0 to 5% and at least one hydrocarbon as outlined above. In some embodiment, the mixed refrigerant can contain, in addition to CO₂ and possibly nitrogen, from 10 to 70% of one or more hydrocarbons with 3 carbon atoms, from 1 to 60% of one or more hydrocarbons containing 4 carbon atoms and from 1 to 30% of one or more hydrocarbons containing 5 carbon atoms.

Percentages are expressed in volume.

In CO₂ separation and liquefaction, the advantage of using a mixed refrigerant over conventional refrigerants or even CO₂ alone is on the one hand the reduction of the compression energy required for liquefaction of the CO₂ by using refrigerant species that have a higher specific heat of evaporation. On the other hand, using CO₂ as one of the ingredients of the mixed refrigerant has the advantage that the boiling point of the refrigerant is similar to the optimal operating conditions for CO₂ separation. The resulting high refrigerant pressure ensures a high energy density and thus minimizes equipment volumetric size requirements.

In the system described above streams of liquefied carbon dioxide from the first separation drum, the second separation drum and third separation drum are collected at the suction side of the pumping unit 49 to increase the pressure thereof and liquid carbon dioxide. The carbon dioxide flowing through the heat exchange section 61.1 removes heat from the heat exchanger and the temperature and pressure thereof may increase up to the final pressure and temperature values which are required in an outlet pipeline or storage unit. The carbon dioxide at the outlet of the heat exchanger 37 can be in a liquid or in a supercritical condition.

While a pumping unit 49 is usually desirable, in some embodiments the pressure of the liquefied carbon dioxide at the liquid outlet of each separation drum can be sufficiently high to maintain the liquid or supercritical state at the outlet of the heat exchanger 37. In such case, the pumping unit 49 can be dispensed with and the final pressure of the separated carbon dioxide collected in the pressurized CO₂ outlet duct 61 is achieved by compression of the flue gas in the compressor unit 11.

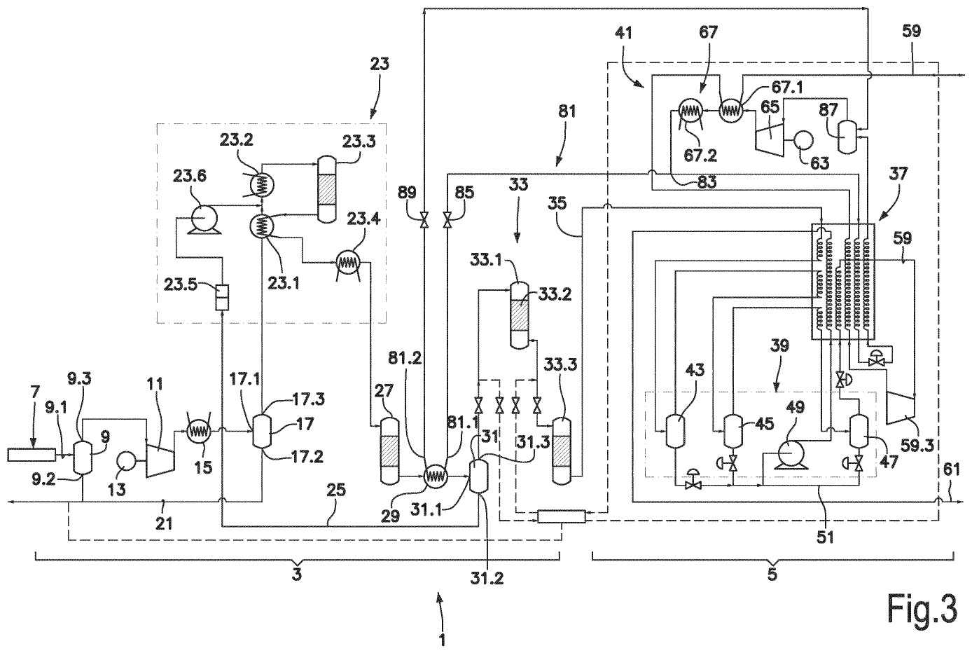

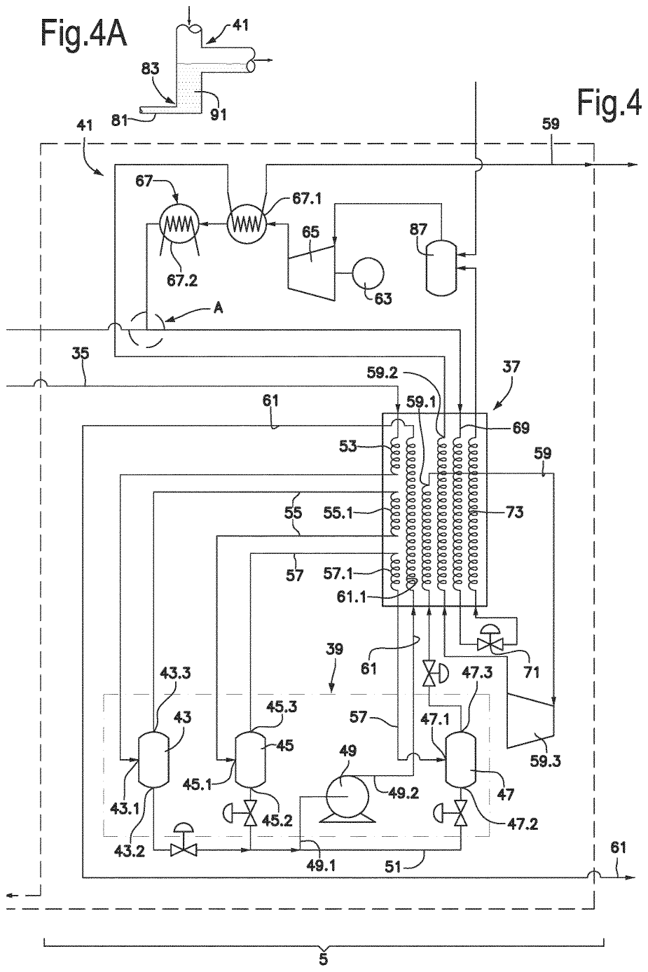

A further embodiment of a plant according to the present disclosure is shown in FIGS. 3, 4 and 4A.

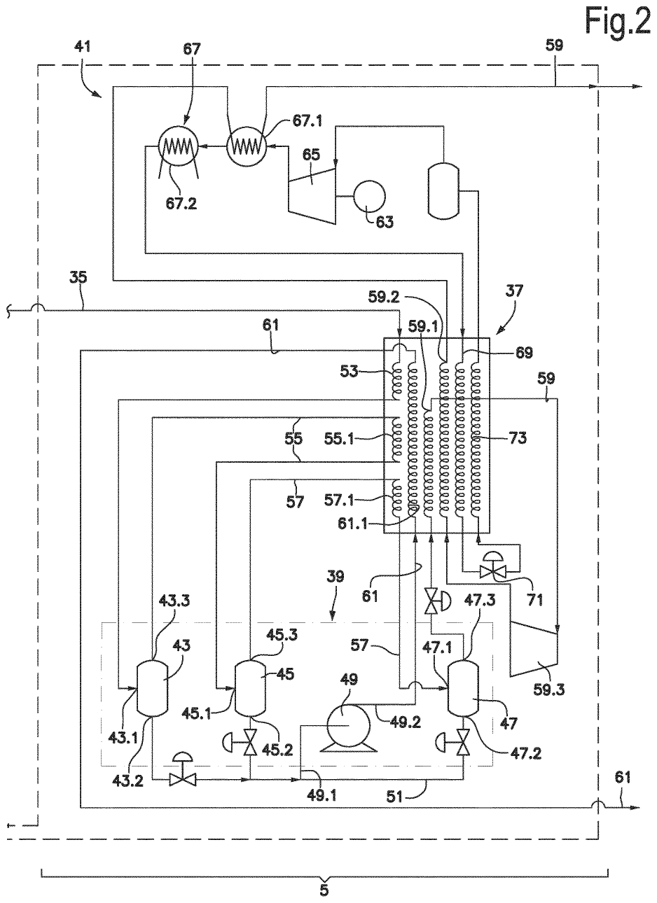

In FIGS. 3 and 4 the same reference numbers indicate the same elements illustrated in FIGS. 1 and 2 and described above. These elements are not described again in detail.

The embodiment of FIGS. 3 and 4 differs from the embodiment of FIGS. 1 and 2 mainly in the manner in which the flue gas is pre-cooled upstream of the liquid-vapor separator 31 and upstream of the dryer arrangement 33. An efficient pre-cooling is of beneficial, since it reduces the volume flowrate of flue gas streaming through the dryer arrangement 33 and therefore the volume of the dryer arrangement 33 and the desiccant bed 33.2 thereof. The desiccant regeneration is also improved and rendered less energy consuming.

In prior art CO₂ separation systems, flue gas is usually pre-cooled before being processed in the cryogenic CO₂ separation system in a cooler against air or water, i.e. against ambient heat sinks. This results in a large amount of water still contained in the pre-cooled flue gas processed through the dryer arranged upstream of the cryogenic separator. The same situation may arise in the system of the present disclosure, when the cooler 29 (FIGS. 1, 2) is operated with water or air as a cooling medium. Large amount of water in the pre-cooled flue gas entering the dryer arrangement 33 requires large volume desiccant beds 33.2 and also require large drying agent regeneration systems.

In the embodiment of FIGS. 3 and 4 this issue is addressed and alleviated in that in the pre-treatment section 3 the flue gas is pre-cooled in the cooler 29 upstream of the dryer arrangement 33 against a side stream of the refrigerant, diverted from the closed refrigeration circuit 41 and providing efficient cooling of the incoming flue gas upstream of the liquid-vapor separator 31.2 and of the dryer arrangement 33. Efficient pre-cooling in the cooler 29 results in improved moisture removal from the flue gas.

Specifically, in the embodiment of FIGS. 3 and 4 the flue gas flows through the hot side of the cooler 29 and heat is removed therefrom by heat exchange against a side stream refrigerant which is diverted from refrigeration circuit 41 and which flows through the cold side of the cooler 29. Exhausted, depressurized refrigerant from the outlet of the cold side of the cooler 29 is returned to the closed refrigeration circuit 41.

More specifically, downstream of the refrigerant condenser 67.2 in the closed refrigeration circuit 41 the refrigerant flow can contain a fraction of liquefied refrigerant and a fraction of gaseous refrigerant. When a mixed refrigerant is used in the closed refrigeration circuit 41, the liquid fraction contains the heavier species of the refrigerant, which have a higher liquefaction temperature.

A portion of the liquefied refrigerant is separated as a side stream from the main closed refrigeration circuit 41 and is diverted to a pre-cooling line 81. Reference number 83 indicates the inlet of the pre-cooling line 81. The inlet 83 is positioned in the high-pressure section of the refrigeration circuit 41, downstream of the condenser 67.2.

The pre-cooling line 81 extends through the cold side of the cooler 29. The cold side inlet is labeled 81.1 and at the cold side outlet is labeled 81.2. Between the inlet 83 of the pre-cooling line 81 and the cold side inlet 81.1 an expansion device 85, such as an expander or an expansion valve 85 is positioned.

In some embodiments, the refrigerant diverted from the refrigeration circuit 41 towards the cooler 29 is expanded in the expansion device 85 from a higher pressure, around the delivery pressure of the compressor section 65, to a lower pressure, around the suction pressure of the compressor section 65. The lower pressure at which the refrigerant side stream is expanded is approximately equal to the pressure in a suction drum 87, positioned upstream of the suction side of the compressor section 65, i.e. in the low-pressure section of the refrigeration circuit 41.

The suction drum 87 also collects the expanded and exhausted refrigerant returning from the heat absorption flow path 73, which extends through the heat exchanger 37. Thus, the pressure of the return refrigerant side stream which flows back from the cooler 29 to the suction side of the compressor section 65 of the refrigeration circuit 41 is approximately the same as the pressure of the exhausted refrigerant returning to the compressor section 65 from the heat exchanger or cold box 37.

The low temperature of the expanded refrigerant, which flows through the cold side of the cooler 29, cools the flue gas flowing through the cooler 29 at a temperature which can be substantially lower than the temperature achieved in a cooler in which the flue gas is cooled against an ambient heat sink, such as air or water. A more efficient water condensation is achieved and therefore more water is removed from the flue gas flowing through in the liquid-vapor separator 31, upstream of the dryer arrangement 33.

Less moisture needs to be removed from the flue gas by the dryer arrangement 33. Moreover, the lower flue gas temperature results in a reduction of the volume flowrate of the flue gas flowing through the dryer arrangement 33. A smaller amount of desiccant is thus required, and an easier regeneration of the desiccant in the dryer arrangement 33 is achieved.

In some embodiments, as shown in FIG. 3, a second expansion device 89, such as an expansion valve or an expander, can be positioned in the return portion of the pre-cooling line 81, between the cold side outlet 81.2 of the cooler 29 and the suction drum 87. In such case, expansion of the refrigerant side-stream is performed in two steps, one in the expansion device 85 upstream of the cooler 29, and one in the expansion device 89 downstream of the cooler 29. The final pressure of the refrigerant downstream of the expansion device 89 is still around the suction pressure at the suction side of the compressor section 65, i.e. the pressure in the suction drum 87. However, the temperature of the refrigerant entering the cold side of the cooler 29 is higher than if all the expansion were performed in a single expansion device 85 upstream of the cooler 29. The second expansion device 89 can be foreseen in order to avoid too low a temperature to be achieved by the flue gas in the cooler 29, and thus to avoid formation of solid hydrates upstream of the dryer arrangement 33.

The expansion devices 85, 89 cumulatively form an expansion arrangement, which is adapted to depressurize the refrigerant side stream from a refrigerant high-pressure, at the inlet 83 of the pre-cooling line 81, to a low pressure of the suction drum 87, forming part of the low-pressure section of the closed refrigeration circuit 41.

In some embodiments, two expansion valves 85, 89 can be positioned along the cooling line 81 and controlled such that the correct temperature of the flue gas exiting the cooler 29 is achieved. This may require partialization or full opening of the second expansion valve 89, depending upon the operating conditions of the system.

FIG. 4A illustrates a schematic connection between the main closed refrigeration circuit 41 and the cooling line 81. The liquefied fraction of refrigerant from the refrigerant condenser 67.2 collects in a tank 91, wherefrom part of the liquefied refrigerant is withdrawn through the pre-cooling line 81. Liquefied refrigerant which is not diverted to the pre-cooling line 81 flows, along with the gaseous fraction of said refrigerant, towards the heat rejection flow path 69, the refrigerant expansion device 71, and the heat absorption flow path 73.

As mentioned, the refrigerant can be advantageously a mixed refrigerant. In some embodiments, the mixed refrigerant can include carbon dioxide and one or more of nitrogen, and hydrocarbons containing from 2 to 5 carbon atoms, such as propane, butane, isobutane, pentane, isopentane, for instance.

In general, the mixed refrigerant composition is selected such that the ambient heat sink (refrigerant condenser 67.2), in which the compressed mixed refrigerant is cooled, is able to generate a liquid fraction of mixed refrigerant, and the composition of the mixed refrigerant is formulated such that the suction conditions at the suction side of the compressor section 65, i.e. at the suction drum 87 from the CO₂ separation and liquefaction system, are matched by the operating conditions of the cooler 29.

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1. A plant for producing liquid CO₂ out of a flue gas, the plant comprising:
a heat exchanger adapted to receive a compressed inlet flue gas stream and condense at least part of the CO₂ contained in the compressed flue gas stream;
a first separation drum adapted to receive a chilled flue gas stream containing at least partly liquefied CO₂ from the heat exchanger, and to separate liquid CO₂ from the chilled flue gas stream;
wherein the first separation drum comprises an inlet, a liquid outlet, and a gas outlet;
a pressurized CO₂ outlet duct extending through the heat exchanger, wherethrough pressurized CO₂ is removed from the plant; wherein the liquid outlet of the first separation drum is fluidly coupled with the pressurized CO₂ outlet duct; and
a closed refrigeration circuit adapted to circulate a refrigerant through the heat exchanger and chill the compressed flue gas therewith.

2. The plant of claim 1, wherein the refrigeration circuit comprises:
a refrigerant compressor;
a refrigerant cooling and condensing section;
a refrigerant expansion device;
a heat rejection flow path extending through the heat exchanger between the refrigerant cooling and condensing section and the refrigerant expansion device and adapted to remove heat from the refrigerant; and
a heat absorption flow path between the refrigerant expansion device and the compressor, adapted to absorb heat from the flue gas flowing through the heat exchanger.

3. The plant of claim 1, further comprising:
at least a further separation drum adapted to receive a chilled flue gas stream containing at least partly liquefied CO₂ from the heat exchanger, and to separate liquid CO₂ from the chilled flue gas stream; wherein the further separation drum comprises an inlet, a liquid outlet, and a gas outlet;
and wherein the liquid outlet of the further separation drum is fluidly coupled with the pressurized CO₂ outlet duct; and
a fluid connection between the gas outlet of the first separation drum and the inlet of the further separation drum, the fluid connection extending through the heat exchanger.

4. The plant of claim 3, wherein the fluid connection between the gas outlet of the first separation drum and the inlet of the further separation drum comprises:
at least an intermediate separation drum adapted to receive a chilled flue gas stream containing at least partly liquefied CO₂ from the heat exchanger, and to separate liquid CO₂ from chilled flue gas stream; wherein the intermediate separation drum comprises an inlet, a liquid outlet, and a gas outlet; wherein the liquid outlet of the intermediate separation drum is fluidly coupled with the pressurized CO₂ outlet duct; and
a connection duct fluidly coupling the gas outlet of the first separation drum with the inlet of the intermediate separation drum, the connection duct extending through the heat exchanger.

5. The plant of claim 1, further comprising a pumping unit having a suction side fluidly coupled with each separation drum and a delivery side fluidly coupled with the pressurized CO₂ outlet duct; wherein the pump unit is adapted to: remove liquid CO₂ from each separation drum, pressurize the removed liquid CO₂, and circulate the pressurized CO₂ in the pressurized CO₂ outlet duct through the heat exchanger.

6. The plant of claim 1, wherein the pressurized carbon dioxide in the pressurized CO₂ outlet duct is in a liquid or supercritical state.

7. The plant of claim 1, wherein the refrigeration circuit contains a mixed refrigerant comprising at least CO₂ and a second component having a boiling point temperature higher than CO₂.

8. The plant of claim 1, wherein the gas outlet of the further separation drum is fluidly coupled with a gas discharge duct extending through the heat exchanger.

9. The plant of claim 8, wherein an expansion device is arranged along the gas discharge duct, adapted to expand gas from the gas outlet of the further gas separator; and wherein the gas discharge duct extends from a delivery side of the expansion device through the heat exchanger.

10. The plant of claim 8, wherein the gas discharge duct extends through a cold side of a refrigerant cooler of the refrigeration circuit.

11. The plant of claim 1, for wherein the refrigeration circuit contains a mixed refrigerant.

12. The plant of claim 11, wherein the mixed refrigerant comprises:
a blend comprising CO₂ and at least one or more hydrocarbons, in particular containing from 1 to 5 carbon atoms, preferably from 3 to 5 carbon atoms; or
a blend comprising at least two hydrocarbons, in particular containing from 1 to 5 carbon atoms, preferably from 3 to 5 carbon atoms.

13. The plant of claim 12, wherein the one or more hydrocarbons are selected from the group consisting of: propane, propylene, pentane, butane, iso-butane, iso-pentane.

14. The plant of claim 1, further comprising a flue gas pre-treatment section.

15. The plant of claim 14, wherein the flue gas pre-treatment section comprises a dryer arrangement.

16. The plant of claim 15, comprising a cooler arranged upstream of the dryer arrangement and adapted to pre-cool the flue gas.

17. The plant of claim 16, further comprising a liquid-vapor separator between the cooler and the dryer arrangement, adapted to remove condensate forming in the flue gas by pre-cooling the flue gas in the cooler.

18. The plant of claim 16, wherein the cooler comprises a hot side adapted to flow flue gas there through, in heat exchange with a refrigerant side stream from the refrigeration circuit.

19. The plant of claim 18, comprising a pre-cooling line, extending from a high-pressure section of the refrigeration circuit, through a cold side of the cooler, and fluidly coupled to a low-pressure section of the refrigeration circuit; wherein the pre-cooling line includes an expansion arrangement; and wherein the expansion arrangement comprises at least one expansion device arranged upstream of the cooler and adapted to expand the refrigerant side stream.

20. The plant of claim 19, wherein the expansion arrangement is adapted to depressurize the refrigerant side stream from a high-pressure, at the inlet of the precooling line, to a low-pressure of the low-pressure section of the refrigeration circuit.

21. The plant of claim 15, wherein the flue gas pretreatment section comprises a filter section downstream of a dryer section of the dryer arrangement.

22. The plant of claim 14, wherein the pre-treatment section comprises a water gas shift reactor unit.

23. The plant of claim 14, wherein the pre-treatment section comprises a flue gas compressor.

24. A method for producing liquid CO₂ out of a flue gas, the method comprising the following steps:
delivering a stream of compressed flue gas containing CO₂ through a heat exchanger in heat exchange with a refrigerant circulating in a closed refrigeration circuit;
at least partially condensing CO₂ contained in the compressed flue gas by heat exchange with said refrigerant;
separating a first stream of pressurized liquid CO₂ from the stream of compressed flue gas in a first separation drum;
removing the first stream of pressurized liquid CO₂ from the first separation drum; and
flowing the first stream of pressurized CO₂ through a CO₂ outlet duct extending through the heat exchanger and removing the first stream of pressurized CO₂ from the heat exchanger.

25. The method of claim 24, further comprising the following steps:
flowing the compressed flue gas from the first separation drum through the heat exchanger and into a further separation drum;
at least partially condensing CO₂ contained in the flue gas flowing from the first separation drum to the further separation drum by heat exchange with said refrigerant;
separating a further stream of pressurized liquid CO₂ from the stream of compressed flue gas in the further separation drum;
removing the further stream of pressurized liquid CO₂ from the further separation drum; and
flowing the further stream of pressurized CO₂ through the CO₂ outlet duct and removing the further stream of pressurized CO₂ from the heat exchanger.

26. The method of claim 25, further comprising the following steps:
flowing compressed flue gas from the first separation drum through the heat exchanger into an intermediate separation drum upstream of the further separation drum;
at least partially condensing CO₂ contained in the compressed flue gas flowing from the first separation drum to the intermediate separation drum by heat exchange with said refrigerant;
separating an intermediate stream of pressurized liquid CO₂ from the stream of compressed flue gas in the intermediate separation drum;
removing an intermediate stream of pressurized liquid CO₂ from the intermediate separation drum; and
flowing the intermediate stream of pressurized CO₂ through the CO₂ outlet duct and removing the further intermediate stream of pressurized CO₂ from the heat exchanger.

27. The method of claim 24, wherein the streams of pressurized liquid CO₂ from each separation drum are processed through a pumping unit to increase the pressure thereof before flowing the streams of pressurized CO₂ through the heat exchanger.

28. The method of claim 24, wherein the pressurized CO₂ at an outlet of the heat exchanger is in a liquid or supercritical state.

29. The method of claim 24, wherein the refrigerant is a mixed refrigerant containing CO₂ and at least a second component having a boiling point temperature higher than CO₂.

30. The method of claim 24, wherein the refrigeration circuit contains a mixed refrigerant.

31. The method of claim 30, wherein the mixed refrigerant comprises:
a blend comprising CO₂ and at least one or more hydrocarbons, in particular containing from 1 to 5 carbon atoms, preferably from 3 to 5 carbon atoms; or a blend comprising at least two hydrocarbons, in particular containing from 1 to 5 carbon atoms, preferably from 3 to 5 carbon atoms.

32. The method of claim 29, wherein the one or more hydrocarbons are selected from the group consisting of: propane, pentane, propylene, iso-butane, isopentane.

33. The method of claim 24, further comprising the following steps:
cooling the stream of compressed flue gas containing CO₂ in a cooler and condensing moisture contained in the compressed flue gas;
removing moisture from the cooled stream of compressed flue gas;
after moisture removal, drying the compressed flue gas in a dryer arrangement.

34. The method of claim 33, wherein the step of cooling the stream of compressed flue gas is performed by heat exchange against a side stream of refrigerant diverted from the closed refrigeration circuit.

35. The method of claim 33, wherein the step of cooling the stream of compressed flue gas comprises the following steps:
diverting a compressed refrigerant side stream from the closed refrigeration circuit;
expanding the compressed refrigerant side stream;
removing heat from the compressed flue gas stream by heat exchange against the expanded refrigerant side stream;
returning the expanded refrigerant side stream at a low-pressure section of the closed refrigeration circuit.
